(19) United States
(12) Patent Application Publication
(10) Pub. No.: US 2021/0317807 A1
(43) Pub. Date: Oct. 14, 2021

(54) METHOD FOR PRODUCING A NOZZLE

(71) Applicant: LIEBHERR-COMPONENTS DEGGENDORF GMBH, Deggendorf (DE)

(72) Inventors: Klaus LICHTINGER, Geiselhoering (DE); Richard PIRKL, Regensburg (DE); Alexander PREIS, Regen (DE)

(21) Appl. No.: 15/734,547

(22) PCT Filed: Jun. 4, 2019
(86) PCT No.: PCT/EP2019/064463

§ 371 Date: Jun. 16, 2021

(30) Foreign Application Priority Data
Jun. 6, 2018 (DE) 10 2018 113 508.4

(51) Int. Cl. F02M 61/16; B23K 26/00; B23K 26/382; F02M 61/18

(52) U.S. Cl. CPC F02M 61/168; B23K 26/0093; B23K 2101/006; F02M 61/1806; B23K 26/389

(57) ABSTRACT

The invention relates to a method for producing a nozzle, in which an injection orifice of the nozzle for dispensing fuel is produced by means of laser drilling, and a cavity is formed in the nozzle along the longitudinal expansion thereof. The method is characterised in that the cavity formed in the injector is produced after the injection orifice has been produced.

The present invention relates to a nozzle for injecting fuel.

In internal combustion engines such as diesel engines or also gasoline engines, a fuel is as a rule injected via an injector into a combustion chamber in a specific quantity and for a specific time period. It is necessary in this process due to the very small injection times that are in the microsecond range to open and close the discharge opening of the nozzle at a very high frequency.

Since the functional principle of an injector is familiar to the skilled person, some aspects that are of advantage for the basic understanding of the invention will only be looked at briefly in the following.

An injector typically has a nozzle needle (also: injector needle) that allows a highly compressed fuel to exit outwardly on release of a discharge hole of the injector. This nozzle needle acts in cooperation with this discharge opening as a plug that enables an exit of the fuel when raised. It is therefore accordingly necessary to raise this needle at relatively short time intervals and to allow it to slide back into the discharge opening after a brief period. In this respect, hydraulic servo valves can be used that control the triggering of this movement. It thus becomes possible to convey the required fuel amount into the combustion chamber at the desired times.

It is known from the prior art to produce the very small bores of the orifices using an erosion process.

More in-depth investigations have shown that the surface property (in particular the roughness) of nozzle orifices has a great effect on the emission behavior of the internal combustion engine interacting with the nozzle. In this respect, very smooth orifices have an advantage and make a significant contribution to smaller emission values. The orifices typically produced using an erosion process are therefore hydro-erosively rounded. In this process, an abrasive fluid admixed with grinding particles is pumped through the orifices at high pressure (up to 120 bar), whereby a certain smoothing of the eroded orifices is achieved.

For the aforesaid reasons, there have long been endeavors to produce the orifices by means of laser drilling since this results in a considerably smoother surface than the erosion process with subsequent hydro-erosive rounding. Further advantages result with respect to the cycle time, possible smaller bores, a smaller heat input into surfaces, the fact that no consumables are required, and a better reproducibility of the holes overall.

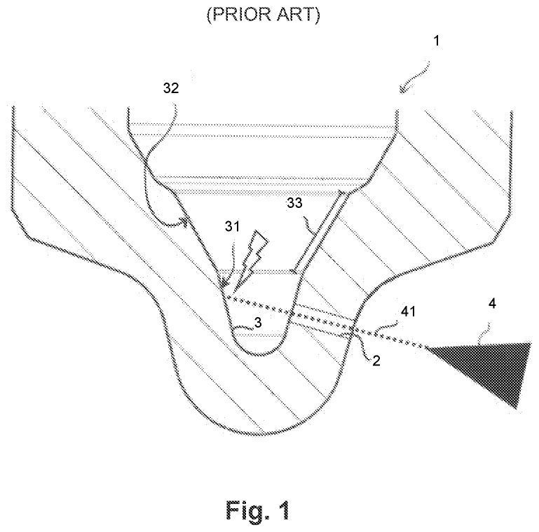

It is problematic in this respect that the laser has to be deactivated directly after the penetration into the blind hole of a nozzle on the laser drilling of the orifice since otherwise the oppositely disposed blind hole wall will be damaged by the laser. A graphical representation of this situation can be found in FIG. 1.

In addition, it can be necessary to produce the orifice such that the laser first penetrates the complete hole and the latter is subsequently enlarged by a circular or helical movement.

However, since it is as a rule not always possible to deactivate the laser sufficiently fast and precisely, it is necessary to screen the oppositely disposed blind hole wall to prevent damage by the laser. This procedure is also called back wall protection in technical circles.

It is the aim of the present invention to simplify the above-described production of orifices by means of laser drilling. This is done on performing all of the method steps of claim 1.

To produce a nozzle, an orifice of the nozzle for discharging fuel is accordingly produced by means of laser drilling and a hole hollowing out the nozzle along its longitudinal extent is produced. The method is characterized in that the hole hollowing out the injector (or nozzle) is produced after the production of the orifice.

Since now in accordance with the invention the orifices are first laser drilled and subsequently the hole hollowing out the nozzle is produced, no damage to the oppositely disposed wall can arise. This is only done by production of the hollowing out hole.

It is consequently possible to dispense with all the protective mechanisms for the blind hole wall. At the same time, the drilling depth of the orifices by the laser is subject to a significantly smaller tolerance since the drilling base that is the front face of the laser bore located in the nozzle is ideally located in the region to subsequently be removed (the hole hollowing out the nozzle).

In accordance with an optional further development of the invention, the hole hollowing out the nozzle comprises or is a blind hole of the injector.

It is clear to the skilled person that there are different forms of the tip of the injector. With a so-called seat hole nozzle, the nozzle holes are directly closed by the valve member (nozzle needle).

With the blind hole nozzle, a resulting volume (in the blind hole) is provided beneath the nozzle seat in which residual fuel remains that was not injected through the nozzle holes. This can have the consequence of an increased emission of non-combusted fuel elements in the exhaust gas and of an increased tendency of the nozzle to coke. However, more favorable flow conditions can be achieved by a mixed volume disposed upstream of the nozzle holes. The invention is not restricted to one of the two aforesaid nozzle forms, but is rather advantageous with both types.

The hole hollowing out the nozzle is preferably configured to receive a nozzle needle and/or a nozzle needle tip. A fluid path between a highly compressed fuel and the orifice can be formed by a movement of the nozzle needle or of the nozzle needle tip in the longitudinal direction of the injector.

The hole hollowing out the nozzle can have different forms, e.g. the hole can be conical or cylindrical.

Provision can be made in accordance with an optional modification that the hole hollowing out the nozzle is produced by means of a bore or by means of a conventional bore.

The orifice produced by means of laser drilling preferably comprises a drilling wall and a drilling base, with the drilling base of the orifice being removed by the production of the hole hollowing out the injector.

The laser bore produces a hole that comprises a drilling wall arranged coaxially to the drilling axis and a drilling base connecting the drilling wall. The drilling base here represents the engagement surface of the laser arranged at the front side of the bore that penetrates more deeply into the injector as the material removal progresses.

In accordance with a preferred embodiment of the invention, the injector is an injector for injecting fuel, that is a fuel injection nozzle, in particular for injecting diesel, that is a diesel injection nozzle. The advantages of a smooth orifice surface are reflected particularly highly with diesel injection nozzles.

Provision can likewise be made in accordance with the invention that a plurality of orifices are produced by means of laser drilling before the production of the hole hollowing out the nozzle.

It is consequently also possible that the plurality of drilling bases of the respective orifices are removed by the production of the hole hollowing out the injector.

In accordance with an optional modification of the present invention, the drilling axis of the orifice includes an angle with the normal plane of the longitudinal extent of the injection that does not exceed 65°, preferably 35°, more preferably 20°. An angle of more than 65! is also possible with certain nozzles. An angle that does not exceed 50° is also advantageous here.

The arrangement of the orifice in the above-named angular ranges is the better for an ideal distribution of the discharged fuel, the lower the deviation of the drilling axis is from the normal plane of the longitudinal extent of the injector.

The present invention additionally relates to an injector for injecting fuel that has been produced in accordance with one of the preceding claims.

Further details, features, and advantages of the invention will be explained with reference to the following description of the Figures. There are shown:

FIG. 1: a sectional view of a nozzle tip during a production method in accordance with the prior art;

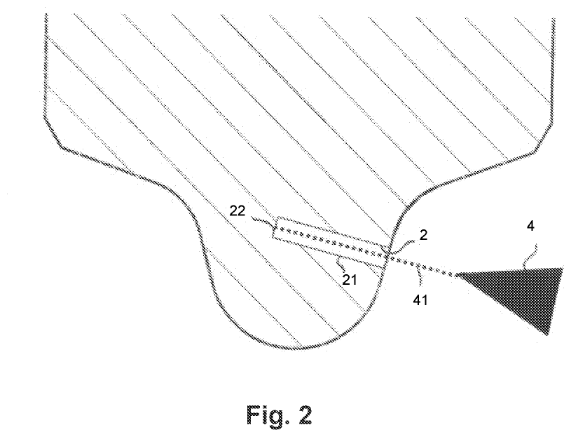

FIG. 2: a sectional view of a nozzle tip during a first production step in accordance with the present invention; and

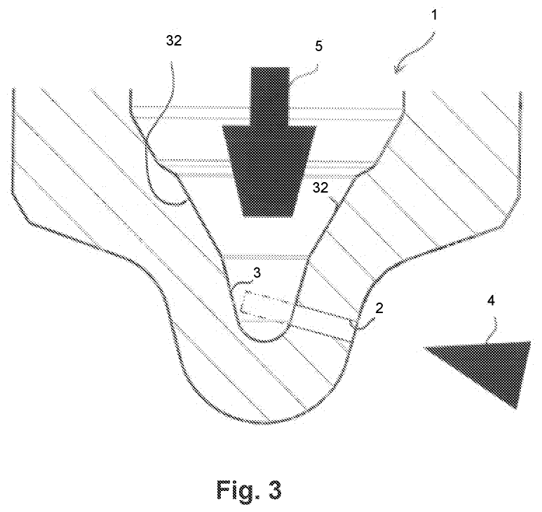

FIG. 3: a sectional view of a nozzle tip during a further production step in accordance with the present invention subsequent to the first production step.

FIG. 1 shows a sectional view of a tip of a nozzle 1 for injecting fuel.

As already explained in the introductory part of the description, it is customary in accordance with the prior art to drill the orifice 2 with the aid of a laser 4. The oppositely disposed region 31 of the blind hole 3 can be damaged in this process after the laser beam 41 has passed through. This damage is graphically shown by a lightning symbol. Such damage must be avoided at all costs since otherwise the injector becomes unusable. An approximately funnel-shaped region 32 that expands upwardly away from the tip of the nozzle adjoins the blind hole 3 here. This region can also have a cylindrical shape. It is the seat region 33 of the nozzle needle that, in interaction with the nozzle needle, can interrupt or permit a fluid communication of highly compressed fuel (and thus the discharge of fuel through the nozzle).

FIG. 2 shows a first step for producing a nozzle 1 in accordance with the invention. In this respect, the at least one orifice 2 is produced by laser drilling in the nozzle blank or in a nozzle whose blind hole and/or seat surface has not yet been produced. The hole produced by the laser 4 has a drilling wall 21 and a drilling base 22. The drilling base 22 is here the region to be removed by the laser beam 41.

FIG. 3 shows a production step that follows the production of the at least one orifice 2. The blind hole 3 of the nozzle 1 Is produced with the aid of a drill 5 in this process. The bore effected by means of a laser 4 in the preceding step is shown by a dashed line, said bore having been partially removed by the blind hole production in a section running toward the drilling base 22.

No measures have to be taken to protect the side 31 of the blind hole 3 disposed opposite the laser from an unwanted action of the laser 4 since the blind hole 3 is only drilled after the laser drilling of the orifice 2.

1. A method of producing a nozzle wherein in said method:
an orifice of the nozzle for discharging fuel is produced by means of laser drilling; and
a hole hollowing out the nozzle along its longitudinal extent is produced, wherein
the hole hollowing out the injector nozzle is produced after the production of the orifice.

2. The method of claim 1, wherein the hole hollowing out the nozzle comprises or is a blind hole of the nozzle.

3. The method of claim 2, wherein the hole hollowing out the nozzle is configured to receive either or both of a nozzle needle and a nozzle needle tip.

4. The method of claim 3, wherein the hole hollowing out the nozzle is produced by means of a bore.

5. The method of claim 4, wherein the orifice produced by means of laser drilling comprises a drilling wall and a drilling base and the drilling base of the orifice is removed by the production of the hole hollowing out the nozzle.

6. The method of claim 5, wherein the nozzle is a nozzle for injecting fuel.

7. The method of claim 6, wherein a plurality of orifices are produced by means of laser drilling before the production of the hole hollowing out the nozzle.

8. The method claim 7, wherein the plurality of drilling bases of the respective orifices are removed by the production of the hole hollowing out the nozzle.

9. The method of claim 8, wherein a drilling axis of the orifice includes an angle with a normal plane of the longitudinal extent of the nozzle that does not exceed 65°.

10. A nozzle for injecting fuel that has been produced in accordance with the method of claim 1.

11. A nozzle for injecting fuel that has been produced in accordance with the method of claim 9.

12. The method of claim 1, wherein the hole hollowing out the nozzle is a blind hole of the nozzle.

13. The method of claim 4, wherein the bore is a conventional bore.

14. The method of claim 6, wherein the nozzle is a nozzle for injecting diesel.

15. The method of claim 9, wherein the plane of the longitudinal extent of the nozzle does not exceed 35°.

16. The method of claim 9, wherein the plane of the longitudinal extent of the nozzle does not exceed 20°.
